(19) United States
(12) Patent Application Publication
(10) Pub. No.: US 2016/0070064 A1
(43) Pub. Date: Mar. 10, 2016

(54) OPTICAL FIBER ANNULAR HEATING PROCESSING APPARATUS

(71) Applicant: AFL TELECOMMUNICATIONS LLC, Duncan, SC (US)

(72) Inventor: William KLIMOWYCH, Duncan, SC (US)

(73) Assignee: AFL TELECOMMUNICATIONS LLC, Duncan, NC (US)

(21) Appl. No.: 14/773,900

(22) PCT Filed: May 22, 2014
(86) PCT No.: PCT/US2014/039217

§ 371 Date: Sep. 9, 2015

Related U.S. Application Data
(60) Provisional application No. 61/826,292, filed on May 22, 2013.

(51) Int. Cl. G02B 6/25; B23K 26/324; B23K 26/21; G02B 5/00; G02B 19/00

(52) U.S. Cl. CPC G02B 6/25; G02B 5/001; G02B 19/0019; B23K 26/21; B23K 26/324; B23K 2203/50

(57) ABSTRACT

A heating apparatus, including a laser beam, an axicon reflector, which redirects the laser beam to generate a conical beam, and a reflecting structure, which redirects the conical beam to create a heating area.

### CROSS-REFERENCE TO RELATED APPLICATION

This application is based upon and claims the benefit of priority from United States Provisional Application No. 61/826,292, filed May 22, 2013, in the United States Patent and Trademark Office, the disclosures of which are incorporated herein in its entirety by reference.

### BACKGROUND

1. Field

The invention is related to a method of providing consistent uniform and controlled zone heat at a fiber's surface using a CO2 laser with axicon reflective elements.

2. Related Art

Approaches that have been presented in the generation of conical and cylindrical beams are typically refractive (see e.g., Zeng, D., Latham, W. P. and Kar, A. (2006), “Optical trepanning with a refractive axicon lens system”, Proc. SPIE 6290, Laser Beam Shaping VII, 62900J (Aug. 31, 2006); doi:10.1117/12.684102.), and demonstrate the projection of quasi Laguerre Gaussian profiles, such as LG 02 modes (see e.g.,

http://laser.physics.sunysb.edu/˜alex/tmodes/webreport.html and FIGS. 1 (Quasi Laguerre Gaussian beam profile) and 2 (LG 02 mode)). Cylindrical annular beams and conical beams have been demonstrated for trepanning, ablating and sputtering materials by Zeng. An expanded cylindrical beam method using a parabolic mirror has been explored by Wysocki, et al. (see e.g., U.S. Pat. No. 5,299,274) at the Hughes Research facility for fiber processing. Current methods use two opposing beams to heat and condition glass fibers up to 2.3 mm. See e.g., FIG. 3.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

According to an exemplary embodiment of the invention, the heating apparatus includes a laser beam, an axicon reflector, which redirects the laser beam to generate a conical beam, and a reflecting structure, which redirects the conical beam to create a heating area.

In this exemplary embodiment, the reflecting surface could be an internally reflecting cylinder.

According to a second exemplary embodiment of the invention, the heating apparatus includes a laser beam, an axicon reflector, which redirects the laser beam to generate a conical beam, and a first reflecting structure, which redirects the conical beam to a second reflecting structure, wherein the second reflecting structure redirects the conical beam to create a heating area.

In this exemplary embodiment, the first reflecting surface may have a conical surface, which redirects the conical laser beam, and an aperture, through which the laser beam passes, and the second reflecting surface may have a conical surface, which redirects the conical laser beam to create the heating area. Also, the second reflecting surface may have a curved conical surface, which redirects the conical laser beam to create said heating area. Also, the second reflecting surface may have a parabolic conical surface, which redirects the conical laser beam to create the heating area.

According to a second exemplary embodiment of the invention, the heating apparatus includes a laser beam, an axicon reflector, which redirects the laser beam to generate a conical beam, and a first reflecting structure, which redirects the conical beam to a second reflecting structure, wherein the second reflecting structure redirects the conical beam back to the first reflecting structure, which redirects the conical beam to a third reflecting structure, wherein the third reflecting structure redirects the conical beam to create a heating area.

In this exemplary embodiment, the first reflecting surface may have a conical surface, which redirects the conical laser beam, and an aperture, through which the laser beam passes, the second reflecting surface may have a conical surface, which redirects the conical laser beam, and the third reflecting surface may have an internally reflecting cylinder, which redirects the conical laser beam to create the heating area. Also, the second reflecting surface may have a curved conical surface, which redirects the conical laser beam to create the heating area. Also, the first reflecting surface may have a curved conical surface, which redirects the conical laser beam to create the heating area. Also, the first reflecting surface may have a parabolic curved conical surface, which redirects the conical laser beam to create the heating area.

### BRIEF DESCRIPTION OF THE DRAWINGS

The above and other objects, features, and advantages of the present invention will become more readily apparent from the following detailed description of exemplary embodiments of the invention, taken in conjunction with the accompanying drawings, in which:

FIG. 1 is a quasi Laguerre Gaussian beam profile;

FIG. 2 is an LG 02 mode beam;

FIG. 3 is a related art laser fusion splicing apparatus;

FIG. 4 is a cross-section of a first embodiment of an annular type heating apparatus;

FIG. 5 is a cross-section of a second embodiment of a back reflector;

FIG. 6 is a cross-section of a third embodiment of a back reflector;

FIG. 7 is a cross-section view of a second embodiment of an annular type heating apparatus;

FIGS. 8 and 9 show an example of a conical laser beam that can be created by an axicon reflector;

FIG. 10 is a cross-section view of a third embodiment of an annular type heating apparatus; and

FIGS. 11, 12A, 12B and 13 show examples of applications of the invention.

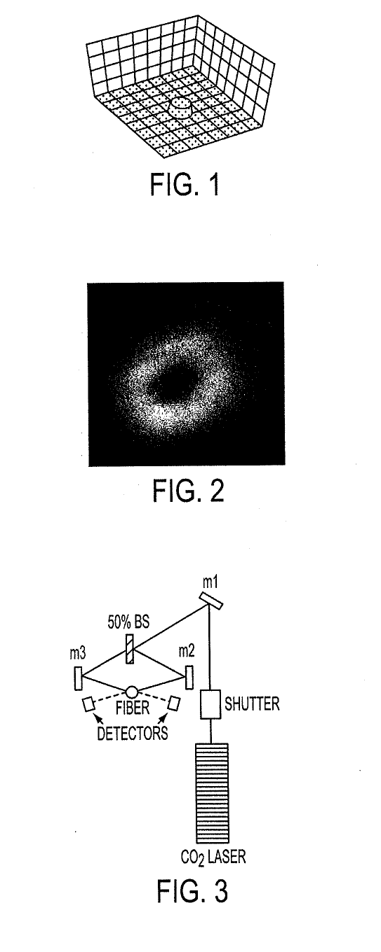

### DETAILED DESCRIPTION

The following detailed description is provided to gain a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

In the following description, like drawing reference numerals are used for like elements, even in different drawings. The matters defined in the description, such as detailed construction and elements, are provided to assist in a comprehensive understanding of exemplary embodiments. However, exemplary embodiments can be practiced without those specifically defined matters, and the inventive concept may be embodied in many different forms and should not be construed as being limited to the exemplary embodiments set forth herein. Also, well-known functions or constructions are not described in detail when it is deemed they would obscure the application with unnecessary detail.

It will be understood that, although the terms used in the present specification may be used herein to describe various elements, these elements should not be limited by these terms. These terms are only used to distinguish one element from another.

An exemplary embodiment of the invention provides consistent uniform and controlled zone heat at a fiber's surface is by using a CO₂ laser with axicon reflective elements. This optical configuration converts a laser beam into a light structure resembling a disc or cone that can band a fiber's perimeter. The characteristic of this structure is its inherent ability to deliver increasing power density through uniform convergence toward the structure's center thus applying the appropriate melting heat to varying sizes of fiber. By offsetting the light structure, precise localized zone heating and annealing of specific areas at a fiber's surface can be achieved as well. This is essentially a passive devise into which active feedback elements can be incorporated to allow precise control of processes such as splicing, tapering, ball and axicon lensing, end capping, and combiner fabrication.

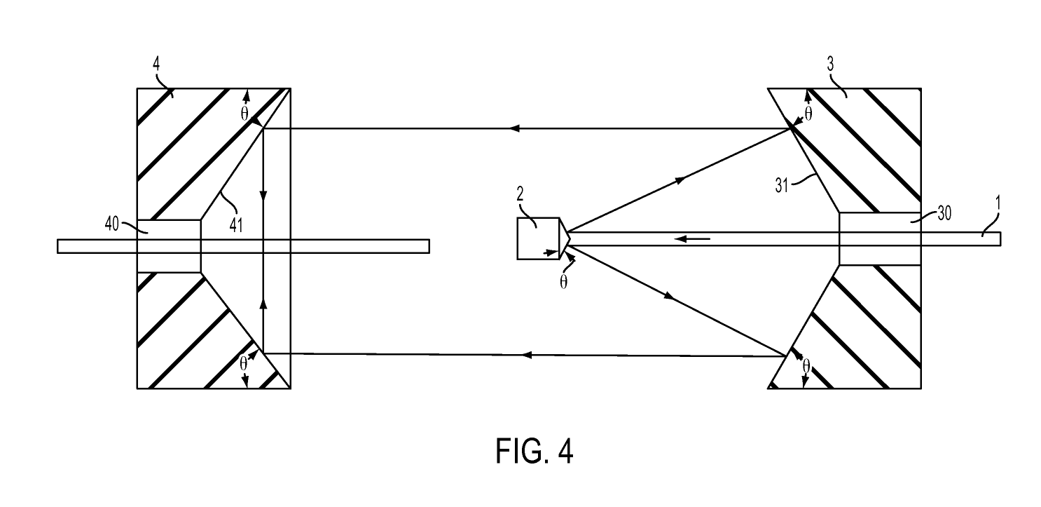

FIG. 4 is a cross-section of a first embodiment of an annular type heating apparatus. It includes an axicon reflector 2 with a cone or tip, a front reflector 3 and a back reflector 4. In this embodiment, the axicon reflector 2 has an angle θ such that a laser beam 1 will reflect in a cone-like shape in a backward direction. In one example, θ is approximately 10 degrees. In another embodiment, the cone or tip of the axicon reflector 2 may be curved, which may have a focusing effect.

The front reflector 3 has an aperture 30, through which laser beam 1 passes. The front reflector 3 has a conical surface 31 and an angle θ such that the cone-like laser beam reflected off of the axicon reflector 2 will be redirected toward the back reflector 4 in a cylindrical like shape. In this embodiment, the conical surface 31 is straight; however, in other embodiments, it could be curved.

The back reflector 4 has an aperture 40, through which fibers may pass, and a conical surface 41 and an angle θ such that the laser beam reflected off of the front reflector 3 will be redirected toward a heating point or area 65. In this particular embodiment, the angle θ is 45 degrees, which cause the laser beam to reflect in a direction perpendicular to the fibers 6 and 5. The laser beam at the heating point or area 65 can generate enough heat to taper a fiber. In this example, fibers 6 and 5 have different diameters, but they could be the same diameter.

The front reflector 3, the axicon reflector 2 and the back reflector 4 may be movable in tandem, or independently, along a axis formed the center of the apertures 30 and 40, to change the cylinder size, thus allowing for axial scanning of the heat zone along the fiber.

The front reflector 3, the axicon reflector 2 and the back reflector 4 should be made of suitable materials such that laser beams can reflect off of their surfaces without damaging them. Examples of such materials include, but are not limited to reflective polished copper and reflective gold-plated copper.

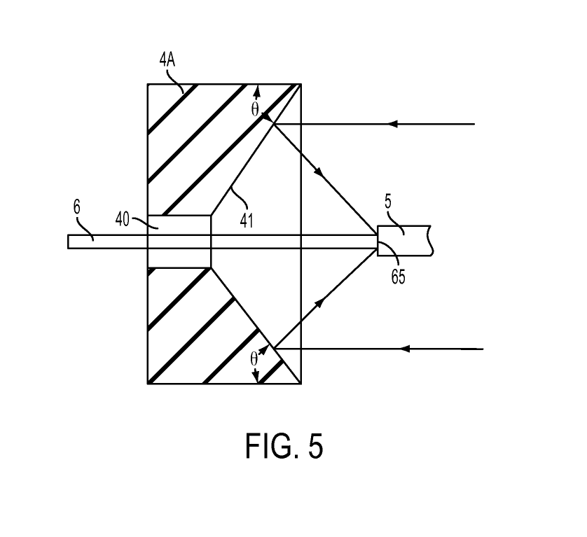

FIG. 5 is a cross-section of a second embodiment of a back reflector 4A. In this embodiment, the angle θ is such that the laser beam reflected off of the front reflector 3 will be redirected toward the heating point 65 or area at an angle other than 45 degrees.

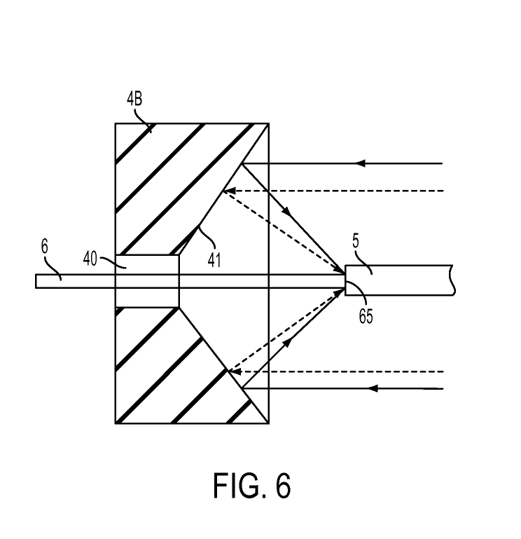

FIG. 6 is a cross-section of a third embodiment of a back reflector 4B. In this embodiment, a conical surface 41 is curved such that the cylindrical laser beam reflected off of the front reflector 3 may be slightly focused and redirected toward the heating point 65 or area at an angle other than 45 degrees, depending on the cylindrical laser beam size from the reflector 3. The conical surface 41 may also be parabolic. The example shows fiber 6 being spliced to fiber 5.

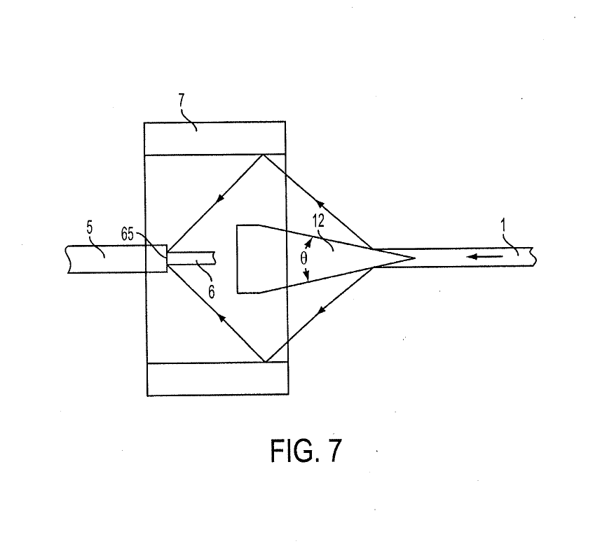

FIG. 7 is a cross-section view of a second embodiment of an annular type heating apparatus. In this embodiment, laser beam 1 hits the tip of an axicon reflector 12 and generates a conical beam. The angle θ is such that the laser beam reflects forward to an internally reflective cylinder 7. The axicon reflector 12 and the internally reflective cylinder 7 are made of suitable materials such that laser beams can reflect off the surface without causing damage. The axicon reflector 12 may also be made of polished reflective tungsten. The conical beam is then redirected toward a heating point 65 or area.

A reflected 635 nm cone projection can be seen in the following demonstration in FIG. 6, and an acrylic burn by CO₂ laser demonstrated in FIG. 7. Both images demonstrate a clear circular pattern that is conducive to evenly heating and melting fiber at proper power densities. This can be set initially by calibrating the source to the optimal melting power level.

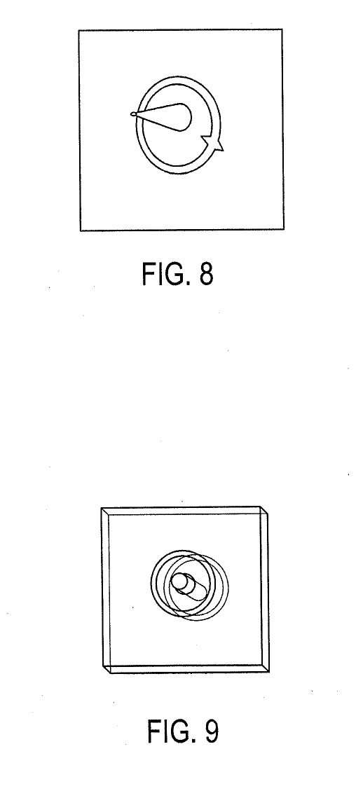

FIGS. 8 and 9 illustrate the methods of zone heating fiber using the projected annular structure. In our experiment the structure is centered about a fiber or fiber bundle, and has also been offset to generate more intense localized heat distribution at specific zones.

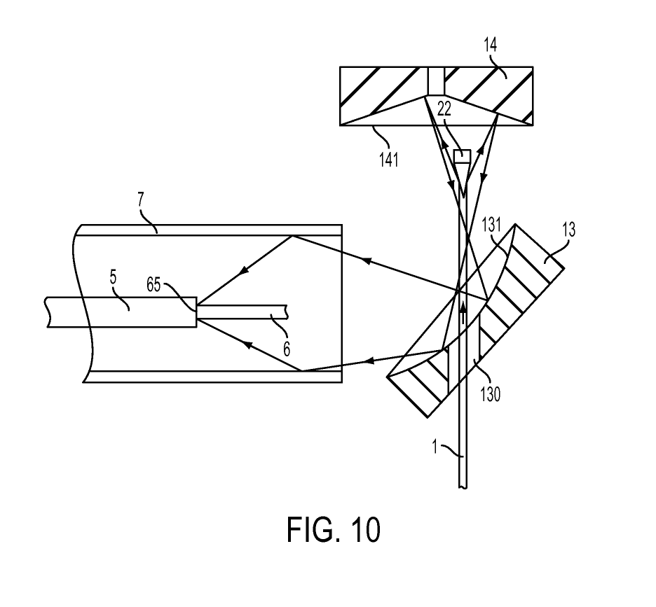

FIG. 10 is a cross-section view of a third embodiment of an annular type heating apparatus. The apparatus includes back reflector 13, an axicon reflector 22, a front reflector 14 and an internally reflective cylinder 7, which are made of suitable materials such that laser beams can reflect off their surfaces without damaging them. The axicon reflector 22 may also be made of reflective polished tungsten. The laser beam 1 passes through an aperture 130 in the back reflector 13, the surface 131 of which may be a 45 degree parabolic mirror. The laser beam 1 hits the tip of the axicon reflector 22 and generates a conical beam onto the back reflector 14, the surface of which has a curved conical surface 141. The back reflector 14 projects a steep conical (almost cylindrical) cone beam back to the front reflector 13. The front reflector 13 then redirects a shallower cone into the internally reflective cylinder 7. The conical beam is then redirected toward a heating point 65.

Some applications of the invention include production of combiners, end caps and tapers.

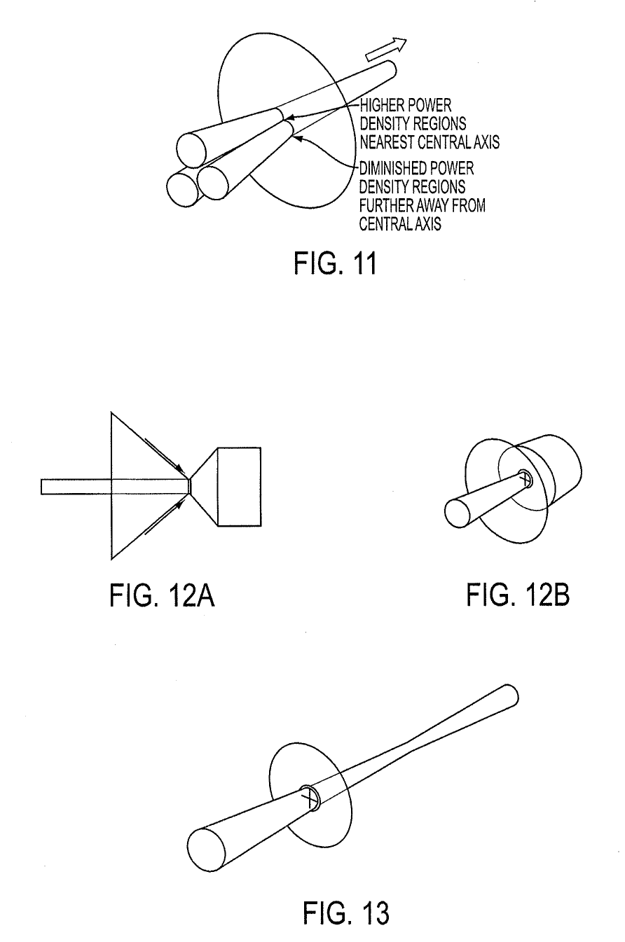

A 3 to 1 fiber combiner is illustrated below, FIG. 11. This 3 to 1 fiber combination can be fused together with other 3 to 1 fiber clusters to create for example, a 9 to 1 combiner. The 9 to 1 can then be used to produce a 27 to 1 combiner, and 27 to 1 can yield a 63 to 1 combiner, and so on.

A conical shaped heat structure is projected onto a large diameter fiber localizing the heating area to match the size of the smaller fiber to be fused into place. See FIGS. 12A and 12B.

As the fiber is drawn through the annular heat structure at controlled rates the precise power density required to melt the changing fiber diameter is maintained, FIG. 13. Power per unit area matches fiber size; the smaller the fiber diameter the higher the power density exhibited toward the center of the structure.

What is claimed:

1. A heating apparatus, comprising:
a laser beam;
an axicon reflector, which redirects said laser beam to generate a conical beam; and
a reflecting structure, which redirects said conical beam to create a heating area.

2. The heating apparatus of claim 1, wherein said reflecting surface is an internally reflecting cylinder.

3. A heating apparatus, comprising:
a laser beam;
an axicon reflector, which redirects said laser beam to generate a conical beam; and
a first reflecting structure, which redirects said conical beam to a second reflecting structure;
wherein said second reflecting structure redirects said conical beam to create a heating area.

4. The heating apparatus of claim 3, wherein:
said first reflecting surface has a conical surface, which redirects said conical laser beam, and an aperture, through which said laser beam passes; and
said second reflecting surface has a conical surface, which redirects said conical laser beam to create said heating area.

5. The heating apparatus of claim 4, wherein:
said second reflecting surface has a curved conical surface, which redirects said conical laser beam to create said heating area.

6. The heating apparatus of claim 4, wherein:
said second reflecting surface has a parabolic conical surface, which redirects said conical laser beam to create said heating area.

7. A heating apparatus, comprising:
a laser beam;
an axicon reflector, which redirects said laser beam to generate a conical beam; and
a first reflecting structure, which redirects said conical beam to a second reflecting structure;
wherein said second reflecting structure redirects said conical beam back to said first reflecting structure, which redirects said conical beam to a third reflecting structure;
wherein said third reflecting structure redirects said conical beam to create a heating area.

8. The heating apparatus of claim 7, wherein:
said first reflecting surface has a conical surface, which redirects said conical laser beam, and an aperture, through which said laser beam passes;
said second reflecting surface has a conical surface, which redirects said conical laser beam; and
said third reflecting surface an internally reflecting cylinder, which redirects said conical laser beam to create said heating area.

9. The heating apparatus of claim 8, wherein:
said second reflecting surface has a curved conical surface, which redirects said conical laser beam to create said heating area.

10. The heating apparatus of claim 8, wherein:
said first reflecting surface has a curved conical surface, which redirects said conical laser beam to create said heating area.

11. The heating apparatus of claim 8, wherein:
said first reflecting surface has a parabolic curved conical surface, which redirects said conical laser beam to create said heating area.
